(19) United States
(12) Patent Application Publication
(10) Pub. No.: US 2008/0194222 A1
(43) Pub. Date: Aug. 14, 2008

(54) MIXING APPARATUS AND METHOD

(75) Inventors: Ren-Chieh LIU, She Tou Hsiang (TW); Chao-Cheng LEE, Hsinchu (TW)

Correspondence Address: Joe McKinney Muncy, PO Box 1364, Fairfax, VA, 22038-1364, US

(73) Assignee: REALTEK SEMICONDUCTOR CORP., Hsinchu (TW)

(21) Appl. No.: 12/030,744

(22) Filed: Feb. 13, 2008

(30) Foreign Application Priority Data
Feb. 14, 2007 (TW) 096105393
Jul. 25, 2007 (TW) 096127026

(51) Int. Cl. H04B 1/10

(52) U.S. Cl. 455/296

(57) ABSTRACT

A mixing apparatus and related methods are provided. The mixing apparatus can filter out unwanted harmonic orders according to demands, to thereby increase circuit attribute performance. Regardless of the type of mixing circuit used for the mixing apparatus, the harmonic interfering phenomenon can be substantially improved.

### CROSS REFERENCE TO RELATED APPLICATIONS

This application claims priority of Application No. 096105393 filed in Taiwan, R.O.C. on Feb. 14, 2007, and Application No. 096127026, filed in Taiwan, R.O.C. on Jul. 25, 2007, under 35 U.S.C. §119; the entire contents of all of which are hereby incorporated by reference.

### BACKGROUND OF THE INVENTION

1. Field of the Invention

The invention relates to a mixer, particularly to a mixer for harmonic rejection.

2. Brief Description of the Related Art

A mixer is an important component in many data communication circuits. A mixer is used for mixing a received signal with a clock signal LO. The above-mentioned process generates not only the expected mixing signal but also the unexpected harmonic orders, thereby interfering the transmitted data, greatly reducing signal-to-noise ratio (SNR), and decreasing the efficiency of the receiver.

FIG. 1 shows a function block diagram illustrating the prior art for overcoming the harmonic problem. The function block diagram 100 comprises an antenna 102, a low noise amplifier (LNA) 104, a mixer 105, a filter 106, a filter 107, and a frequency synthesizer 108, wherein the frequency synthesizer 108 provides a clock signal LO. The signal processing method as illustrated in the above-mentioned FIG. 1, uses the filter 107 to filter out the unwanted harmonic and finally generates an intermediate frequency/IF signal I without the hamonic or a baseband frequency B.

Traditionally, the filter 107 is generally implemented by filters, such as LC filter, Gm-C filter, and OP-RC filter, and so forth. If the filter 107 is implemented by the LC filter and is made as part of the chip, the chip area and the chip cost will be increased due to the quite big value of the conductance L. And, if the L is made on the outside of the chip, the cost will also increase. If the filter 107 is implemented by the Gm-C filter or the OP-RC filter, the noise figure increases to make the linearity decrease and the overall circuit performance get worse. However, no matter how good the filter is adopted, the the chip area and the chip cost increase inevitably.

In light of the above-mentioned description, not only the cost is expensive according to the prior art, but also the circuit attribute cannot achieve the standard of the harmonic interference cancellation that those who are skilled in the art wants to reach. Therefore, an invention for solving the long existing problems in the above-mentioned field is needed urgently.

### SUMMARY OF THE INVENTION

One object of the present invention is to provide a harmonic rejecting mixing apparatus for solving the above-mentioned problem.

One object of the present invention is to provide a harmonic rejecting mixing apparatus for solving the harmonic interference of various frequencies according to the demand.

The present invention provides an equivalent function block structure of a mixing apparatus that can filter out the harmonic orders according to design requirement so as to increase the performance of the circuit. Also, no matter what type and style of the mixing circuit is adopted by the mixing apparatus, the phenomenon of harmonic interference will be greatly improved according to the present invention. The chip designer can also design the circuit to filter out the harmonic orders according to the individual requirement. The circuit design is therefore more flexible. According to the above-mentioned description, the present invention is a novel invention.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 shows a function block diagram illustrating the prior art for overcoming harmonic interference.

FIG. 2 shows a function block diagram illustrating the mixing apparatus according to one embodiment of the present invention.

FIG. 3(a) shows a function block diagram illustrating the mixing apparatus according to one embodiment of the present invention.

FIG. 3(b) shows a function block diagram illustrating the mixing apparatus according to one embodiment of the present invention.

FIG. 3(c) shows a function block diagram illustrating the mixing apparatus according to one embodiment of the present invention.

FIG. 3(d) shows a function block diagram illustrating the mixing apparatus according to one embodiment of the present invention.

FIG. 4 shows a circuit implementation diagram according to one embodiment of FIG. 2, FIG. 3(a), and FIG. 3(b).

FIG. 5 shows a circuit implementation diagram according to another embodiment of FIG. 2, FIG. 3(a), and FIG. 3(b).

FIG. 6 shows a circuit implementation diagram according to one embodiment of FIG. 2, FIG. 3(c), and FIG. 3(d).

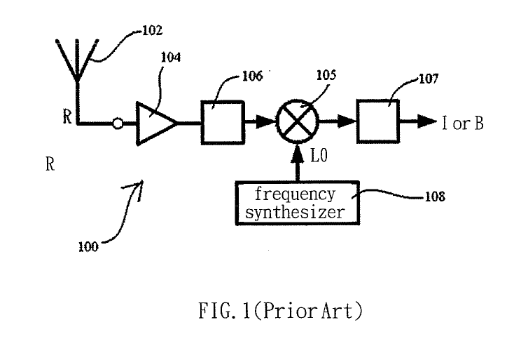

### DETAILED DESCRIPTION OF THE INVENTION

In the past, a filter is used to filter out the harmonic waves that induces interference. However, the present invention provides a mixing apparatus, wherein at least one harmonic of the mixing output signal in the output of the mixing apparatus is eliminated in the mixing apparatus. Therefore, using at least one filter to filter out the harmonic can be omitted. Herein, not only the chip area is reduced, but also the chip cost is relatively reduced to increase the price competability. Besides, the harmoic orders to be filtered can be decided according to the requirement of design objectives. Therefore, the design is extremely flexible. Compared to the prior art, the chip area, the price, and the design flexibility have been greatly improved.

The principle of the present invention can be illustrated by Fourier Series for thorough comprehension. According to the inference of the Fourier Series, the signal LO(t) is actually composed of sinusoidal series of the first order, third order, fifth order, seventh order, and so forth, as illustrated in the following equation:

$$LO ( t ) = sin ( {ω}_{0} t ) + \frac{sin ( 3 {ω}_{0} t )}{3} + \frac{sin ( 5 {ω}_{0} t )}{5} + \frac{sin ( 7 {ω}_{0} t )}{7} + \frac{sin ( 9 {ω}_{0} t )}{9} + \frac{sin ( 11 {ω}_{0} t )}{11} + …$$

$$wherein \frac{sin ( 3 {ω}_{0} t )}{3} , \frac{sin ( 5 {ω}_{0} t )}{5} , \frac{sin ( 7 {ω}_{0} t )}{7} , \frac{sin ( 9 {ω}_{0} t )}{9} ,$$

and so forth belong to the part of the harmonic orders which will interfere with the signal. Therefore, if the interfering harmonic orders are eliminated, the SNR value can be increased to increase the circuit performance. The present invention adopts this principle to achieve the objective of harmonic rejection accordingly. The following equation can be utilized to eliminate the harmonic orders from the above-mentioned equation LO(t):

$$\begin{matrix}{V}_{out} ( t ) = R ( t ) \times ( sin ( {ω}_{o} t ) + \frac{sin ( 3 {ω}_{0} t )}{3} + \frac{sin ( 5 {ω}_{0} t )}{5} + … ) - \frac{1}{3} R ( t ) \times \\ ( sin ( 3 {ω}_{0} t ) + \frac{sin ( 9 {ω}_{0} t )}{3} + \frac{sin ( 15 {ω}_{0} t )}{5} + … ) \\ = R ( t ) \times ( sin ( {ω}_{0} t ) + \frac{sin ( 5 {ω}_{0} t )}{5} + … )\end{matrix}$$

The above-mentioned equations Vₒᵤₜ(t) can completely filter out the third order harmonic. Same methods can be used to filter out the fifth order harmonic, the seventh order harmonic, the ninth order harmonic, and so forth.

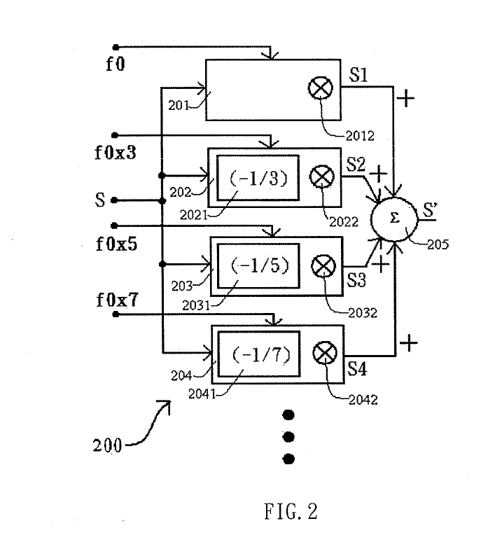

Please refer to FIG. 2. The function block diagram shows a harmonic rejecting mixing apparatus according to one embodiment of the present invention.

As shown in FIG. 2, the harmonic rejecting mixing apparatus 200 comprises a mixing circuit 201, a first circuit 202, a second circuit 203, a third circuit 204, and a summation unit 205. The mixing circuit 201 further comprises a mixing unit 2012, for receiving a signal S and a f₀ and performing mixing of the signal S and the f₀ via the mixing unit 2012 to generate a signal S₁. The first circuit 202 further comprises a gain unit 2021 and a mixing unit 2022, for receiving the signal S and the 3f₀ and performing mixing of the signal S and the 3f₀ via the gain unit 2021 and the mixing unit 2022 to generate a signal S₂. The second circuit 203 further comprises a gain unit 2031 and a mixing unit 2032, for receiving the signal S and the 5f₀ and performing mixing of the signal S and the 5f₀ via the gain unit 2031 and the mixing unit 2032 to generate a signal S₃. The third circuit 204 further comprises a gain unit 2041 and a mixing unit 2042, for receiving the signal S and the 7f₀ and performing mixing the signal S and the 7f₀ via the gain unit 2041 and the mixing unit 2042 to generate a signal S₄. The gain units 2021, 2031, and 2041 convert the signals into the signals having the gain value, and the mixing units 2022, 2032, and 2042 mix the two signals for generating the harmonic signals, which want to be eliminated. Finally, the summation unit 205 sums up the signals S₁, S₂, S₃, and S₄ and then outputs the S′.

Among them, the first circuit (that is, the gain unit 2021 and the mixing unit 2022) can be regarded as the third harmonic eliminating circuit; the second circuit (that is, the gain unit 2031 and the mixing unit 2032) can be regarded as the fifth harmonic eliminating circuit; and the third circuit (that is, the gain unit 2041 and the mixing unit 2042) can be regarded as the seventh harmonic eliminating circuit. Besides, since the signals generated by the third harmonic eliminating circuit comprise the third harmonic, the ninth harmonic, the fifteenth harmonic, and so forth, the ninth harmonic eliminating circuit in the embodiment of the present invention is not needed. In addition, FIG. 2 shows that one embodiment of the harmonic eliminating circuit is also a mixer. The difference is that the frequency of the clock signal is N times the clock signal of the mixing circuit 201 and its gain value of the clock signal is 1/N times the gain value of the mixing circuit 201. Besides, f₀, 3f₀, 5f₀, and 7f₀ are generated by a clock signal generator and the embodiments of which can be: frequency synthesizer, phase-locked loop (PLL), and so forth.

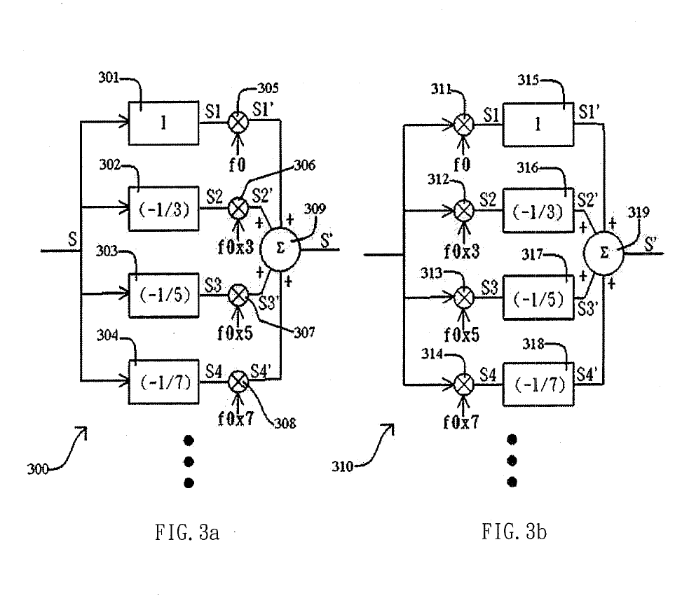

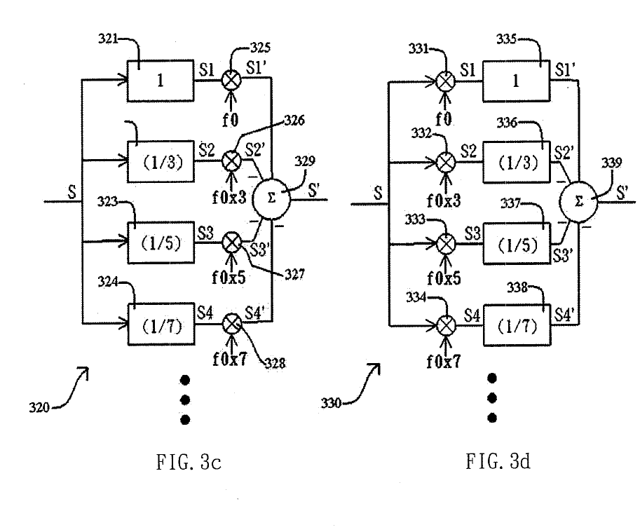

Please refer to FIGS. 3(a), 3(b), 3(c), and 3(d). FIGS. 3(a), 3(b), 3(c), and 3(d) are the function block diagrams illustrating haramonic rejecting mixing apparatus of various embodiments according to the present invention in FIG. 2. Since the processing principle of FIGS. 3(a), 3(b), 3(c), and 3(d) is similar to that of FIG. 2, the detailed description is omitted hereafter.

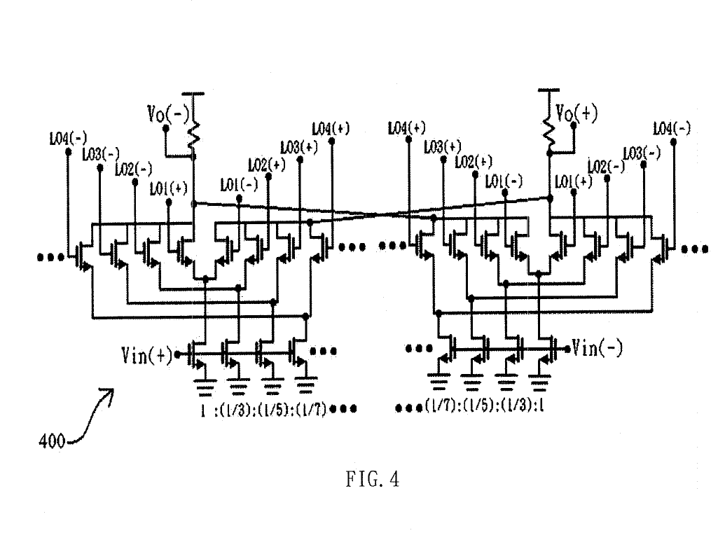

Please refer to FIG. 4. FIG. 4 shows a circuit diagram implementing one embodiment of the present invention. Gilbert mixer is adopted for the implementation of this embodiment and other types of mixers can be applied in the present invention. The functions illustrated in FIG. 2, FIG. 3(a), and FIG. 3(b) are achieved by setting LO1(+)=f₀, LO1(−)=−f₀, LO2(+)=3f₀, LO2(−)=−3f₀, LO3(+)=5f₀, LO3(−)=−5f₀, LO4(+)=7f₀, and LO4(−)=−7f₀. Since Gilbert mixer is a well-known technology for those who are skilled in the art, the description is omitted.

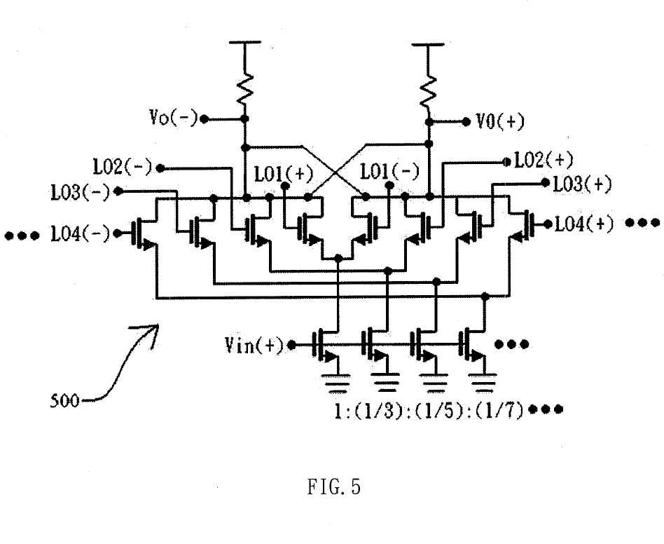

Please refer to FIG. 5. FIG. 5 illustrates a circuit implementation diagram illustrating another embodiment of FIG. 2, FIG. 3(a), and FIG. 3(b). The single-ended mixer is used for the implementation where the functions illustrated in FIG. 2, FIG. 3(a), and FIG. 3(b) are achieved by setting LO1(+)=f₀, LO1(−)=−f₀, LO2(+)=3f₀, LO2(−)=−3f₀, LO3(+)=5f₀, LO3(−)=−5f₀, LO4(+)=7f₀, and LO4(−)=−7f₀. Since the single-ended mixer is a well-known technology for those who are skilled in the art, the description is omitted.

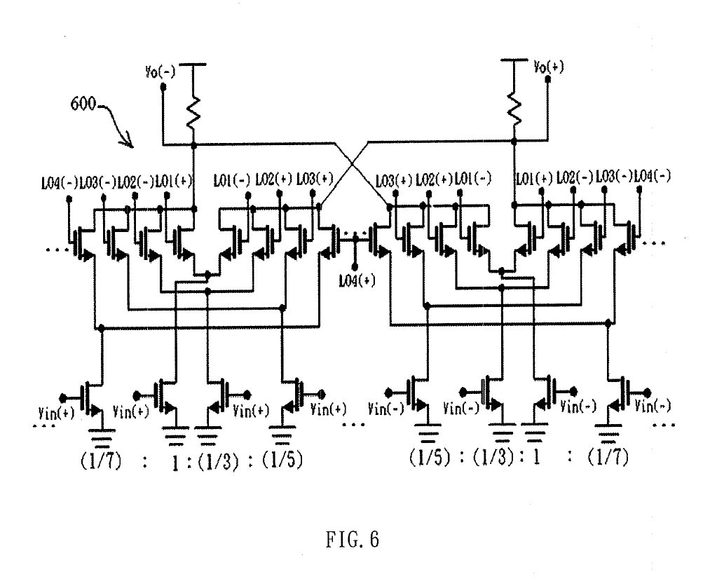

Please refer to FIG. 6. FIG. 6 is a circuit implementation diagram illustrating one embodiment of FIGS. 2, 3(c), and 3(d). The Gilbert mixer is adopted for implementation where the functions illustrated in FIG. 2, FIG. 3(c), and FIG. 3(d) are achieved by setting LO1(+)=f₀, LO1(−)=−f₀, LO2(+)=3f₀, LO2(−)=−3f₀, LO3(+)=5f₀, LO3(−)=−5f₀, LO4(+)=7f₀, and LO4(−)=−7f₀.

In addition, as illustrated in FIGS. 4, 5, and 6, one embodiment of the summation unit of FIG. 2 and FIGS. 3(a)˜3(d) can be a node.

In practical applications, if the signal intensity of the harmonic signal is small, the corresponding harmonic eliminating circuit (that is, the gain unit and the mixing unit) can be omitted. For example, since the signal intensity of the higher orders harmonic signal is small, the harmonic eliminating circuit for the fifth order and the orders higher than the fifth order can be omitted. In other words, only the third order harmonic eliminating circuit is remained. Of course, if more precise signal for back-end circuit processing is required, the third order and the fifth order harmonic eliminating circuits can be kept accordingly.

Although the present invention has been fully described by way of examples with reference to the accompanying drawings, it should not be construed as any limitation on the range of implementation of the invention. Various equivalent changes and modifications of the shape, scope, characteristics, and spirit as described by the claims of the present invention is to be encompassed by the scope of the present invention.

What is claimed is:

1. A mixing apparatus, comprising:
a first mixing circuit to receive an input signal and a first clock signal and output a mixed signal wherein the mixed signal comprises a plurality of harmonic signals;
a harmonic eliminating circuit to output a harmonic eliminated signal wherein the harmonic eliminated signal corresponds to at least one of the harmonic signals; and
a summing circuit, coupled to the first mixing circuit and the harmonic eliminating circuit, for summing the mixed signal and the harmonic eliminated signal to generate an output signal.

2. The apparatus of claim 1, wherein the harmonic eliminating circuit comprises a second mixing circuit for mixing the input signal and a second clock signal to generate the harmonic eliminated signal and there is a multiple relation between the frequencies of the first clock signal and the second clock signal.

3. The apparatus of claim 2, wherein there is a N-multiple relation between the frequencies of the second clock signal and the first clock signal when the harmonic eliminated signal corresponds to the Nth harmonic signal.

4. The apparatus of claim 3, wherein the N is an odd value.

5. The apparatus of claim 2, wherein the harmonic eliminating circuit further comprises a gain circuit for adjusting the gain of the harmonic eliminated signal according to a gain value.

6. The apparatus of claim 5, wherein there is a N-multiple relation between the frequencies of the second clock signal and the first clock signal and the gain value is 1/N.

7. A mixing method, comprising:
receiving an input signal and a first clock signal;
mixing the input signal and the first clock signal to output a mixed signal, wherein the mixed signal comprises a plurality of harmonic signals;
generating a harmonic eliminated signal, wherein the harmonic eliminated signal corresponds to at least one of the harmonic signals; and
summing the mixed signal and the harmonic eliminated signal to generate an output signal.

8. The method of claim 7, wherein the step of generating the harmonic eliminated signal further comprises:
outputting the harmonic eliminated signal by mixing the input signal and a second clock signal.

9. The method of claim 8, wherein there is a multiple relation between the frequencies of the second clock signal and the first clock signal.

10. The method of claim 8, wherein the step of generating the harmonic eliminated signal further comprises:
adjusting the gain of the input signal according to a gain value to output a gain signal.

11. The method of claim 8, wherein there is a N-multiple relation between the frequencies of the second clock signal and the first clock signal and the gain value is 1/N.

12. The method of claim 11, wherein N is an odd value.

13. A mixing apparatus, comprising:
a first mixing circuit for mixing the input signal and a first clock signal to output a first mixed signal, wherein the mixed signal comprises a plurality of harmonic signals;
a second mixing circuit for mixing the input signal and a second clock signal and outputting a second mixed signal corresponding to at least one of the harmonic signals; and
a summing circuit for summing the first mixed signal and the second mixed signal to generate the mixed output signal;
wherein there are a N-multiple relation between the frequencies of the second and the first clock signals, and a 1/N relation between the gains of the second mixed signal and the first mixed signal, and N is a positive integer.

14. The apparatus of claim 13, wherein the N is an odd number.

15. The apparatus of claim 13, wherein the summing circuit is a node.

16. The apparatus of claim 13, further comprising:
a third mixing circuit for receiving the input signal and a third clock signal to output a third mixed signal;
wherein there are a M-multiple relation between the frequencies of the third and the first clock signals, and a 1/M relation between the gains of the third mixed signal and the first mixed signal, and M is a positive integer and M is not equal to N; and
wherein the summing circuit adds the first, the second and the third mixed signals to generate the mixed output signal.

17. The apparatus of claim 16, wherein the N is equal to 3 and the M is equal to 5.

18. The apparatus of claim 13, wherein the second mixing circuit comprises a gain circuit such that there is a 1/N relation between the gains of the second mixed signal and the first mixed signal.

19. The apparatus of claim 13, wherein at least one of the first and second mixing circuit comprises a Gilbert mixer.
